(19) United States
(12) Patent Application Publication
(10) Pub. No.: US 2012/0218225 A1
(43) Pub. Date: Aug. 30, 2012

(54) OPTICAL SCANNING TYPE TOUCH APPARATUS AND OPERATION METHOD THEREOF

(75) Inventors: Hsin-Hsiang Lo, Hsinchu County (TW); Shih-Pin Chao, New Taipei City (TW); Jui-Feng Huang, Hsinchu City (TW); Hsien-Chang Lin, Taipei City (TW); Chun-Chuan Lin, Hsinchu City (TW); Golden Tiao, Hsinchu County (TW); Eric G. Lean, Hsinchu City (TW)

(73) Assignee: INDUSTRIAL TECHNOLOGY RESEARCH INSTITUTE, Hsinchu (TW)

(21) Appl. No.: 13/191,440

(22) Filed: Jul. 26, 2011

(30) Foreign Application Priority Data
Feb. 24, 2011 (TW) 100106236

(51) Int. Cl. G06F 3/042

(52) U.S. Cl. 345/175

(57) ABSTRACT

An optical scanning-type touch apparatus and an operation method thereof are provided. The optical scanning-type touch apparatus includes a touch area, a light scanning module, an imaging module and a calculating unit. The light scanning module is disposed at one corner of the touch area to emit a scanning light for scanning the touch area. The imaging module is disposed at another corner of the touch area adjacent the light scanning module to obtain a first angle between the scattering light and a edge of the touch area, wherein the edge of the touch area is between the light scanning module and the imaging module. The calculating unit receives the first angle, a second angle and a distance between the light scanning module and the imaging module to calculate a position of the object on the touch area.

### CROSS-REFERENCE TO RELATED APPLICATION

This application claims the priority benefit of Taiwan application serial no. 100106236, filed Feb. 24, 2011. The entirety of the above-mentioned patent application is hereby incorporated by reference herein and made a part of this specification.

### TECHNICAL FIELD

This disclosure relates to an optical scanning type touch apparatus and an operation method thereof.

### 2. BACKGROUND

Since the touch technology has made the man-machine interaction easier, users can operate various apparatuses such as, iPhone, iPad, or Windows 7, simply by touching these apparatus with finger. Because of the cost consideration, the optical scanning type touch technology is currently the main technology for use in large-sized display. In addition, the popularization of the large-sized displays gives the optical scanning type touch technology motive force for development. Currently, the main stream optical scanning type touch technology includes dual imaging apparatus, an infrared lighting and an optical reflector. A fixing frame is required for this type of optical scanning type touch apparatus. The size of the fixing frame cannot be adjusted in real time according to the display image size, thus degrading the convenience in use.

U.S. Pat. No. 6,480,187 discloses a touch apparatus. In this touch apparatus, two light emitting/receiving elements are disposed at one side of a screen, and light reflective sheets are disposed at the other three sides. When an object exists in the display area of the screen, the emitted light is reflected back to the light receiving elements by the light reflective sheets at the three sides. On the other hand, if a touch object enters the screen display area, the luminance of the reflected light is reduced. The triangulation measurement method is used to calculate coordinates of the center of the shielded area as the touch point position.

U.S. Pat. No. 6,816,537 discloses a touch apparatus. In this touch apparatus, the switching frequency modulation of the light is used to decode the depth of the touch position. The angle at which the laser beam is emitted is also used to calculate the position of the touch point on a coordinate system.

U.S. Pat. No. 7,538,759 discloses a touch apparatus. In this touch apparatus, a row of infrared light source is disposed at a bottom side of a screen. Positioned at right and left corners of the bottom side are various optical sensors. Light reflecting strips are disposed at the other three sides. A diffusing plate is disposed on the screen panel, and the infrared light source emits a light into the diffusing plate on the screen panel. If there is no touch object above the diffusing plate, the infrared light emitted into the diffusing plate is reflected back to the bottom optical sensors. On the contrary, if there is a touch object presented above the diffusing plate, the touch object blocks the incoming infrared light from being reflected by the reflective strips to the bottom optical sensors, thus forming a shielded area. The position of the touch object in contact with the diffusing plate can be obtained by calculating the position of the shielded area.

U.S. Pat. No. 6,803,906 discloses a touch apparatus. In this touch apparatus, at least two video cameras are disposed at corners of a rectangular screen frame. The touch location is determined by examining the location that is different in two screen image frames captured by the video cameras.

U.S. Patent Application Publication No. 2007/0089915 A1 discloses a touch apparatus. In this touch apparatus, the screen has four side frames. Two two-dimensional infrared cameras with infrared light projecting function are disposed in the top side frame. The other three side frames are reflecting areas. Because a touch area has a light shield effect, lower luminance can be used as a condition to determine a touch location.

U.S. Patent Application Publication No. 2010/0045634 A1 discloses a touch apparatus. In this touch apparatus, laser light emitters are disposed at two corners on a bottom side of a screen, and optical sensors are disposed on the other three sides. Where no touch object presents on the screen, the emitted laser light is received by the optical sensors. However, if there is a touch object entering the screen, the touch object blocks the laser light from entering the optical sensors. As such, the position of the touch point can be obtained according to those optical sensors that do not receive the laser light signal.

### SUMMARY

An optical scanning type touch apparatus is introduced herein, which includes a touch area, a light scanning module, an imaging module, and a calculating module. The light scanning module is disposed at one corner of the touch area and adapted to generate a scanning light scanning the touch area. The imaging module is disposed at another corner of the touch area adjacent the light scanning module and adapted to receive a scattering light produced by the scanning light travelling to an object so as to obtain a first angle. The calculating module is coupled to the light scanning module and the imaging module and adapted to calculate the position of the object on the touch area according to the first angle, a second angle, and a distance between the light scanning module and the imaging module.

An operation method of an optical scanning type touch apparatus is also introduced herein. The optical scanning type touch apparatus includes a light scanning module, an imaging module, and a calculating module. In the operation method, the light scanning module emits a scanning light onto a touch area. The imaging module receives a scattering light produced by the scanning light travelling to an object so as to obtain a first angle between the scattering light and an edge of the touch area when the scattering light travels to the imaging module. The edge is located between the light scanning module and the imaging module. The calculating module calculates the position of the object on the touch area according to the first angle, a second angle, and a distance. The second angle is the angle between the scanning light and the edge of the touch area when the scanning light travels to the object, and the distance is between the light scanning module and the imaging module.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic diagram illustrating an optical scanning type touch apparatus according to one exemplary embodiment.

FIG. 1B is a schematic diagram illustrating the light scanning module of FIG. 1A.

FIG. 2 is a schematic diagram illustrating multi-point touch of the optical scanning type touch apparatus 100 of FIG. 1A.

FIG. 3A is a schematic diagram illustrating an optical scanning type touch apparatus according to another exemplary embodiment.

FIG. 3B is a schematic diagram illustrating the relationship between the time of generating the sensing signal and the time of the driving voltage according to one exemplary embodiment.

FIG. 4A is a schematic diagram illustrating an optical scanning type touch apparatus according to another exemplary embodiment.

FIG. 4B is a schematic diagram illustrating the relationship between the time of generating the sensing signal and the time of the driving voltage according to one exemplary embodiment.

FIG. 5A is a schematic diagram illustrating an optical scanning type touch apparatus according to another exemplary embodiment.

FIG. 5B is a schematic diagram illustrating the image recording sequence of the imaging module and the light switching sequence according to one exemplary embodiment.

FIG. 5C is a schematic diagram illustrating the image recording sequence of the imaging module and the light switching sequence according to another exemplary embodiment.

FIG. 6 illustrates a flow chart of an operation method of an optical scanning type touch apparatus according to one exemplary embodiment.

### DETAILED DESCRIPTION OF DISCLOSED EMBODIMENTS

In exemplary embodiments of this disclosure, a light scanning module generates a scanning light scanning a touch area to determine whether there is an object touching the touch area. When an object touches the touch area, a first angle obtained by an imaging module and a second angle obtained by a light scanning module are transmitted to a calculating module, such that the calculating module calculates the position of the object touching the touch area according to the first angle, the second angle and a distance between the light scanning module and the imaging module. As such, these exemplary embodiments can successfully obtain the correct position of the object touching the touch area. In addition, these exemplary embodiments utilize only one light scanning module and one imaging module, thus reducing the cost of circuit components. Besides, the distance between the light scanning module and the imaging module can be adjusted in real time such that the optical scanning type touch apparatus can fit for touch area of any size.

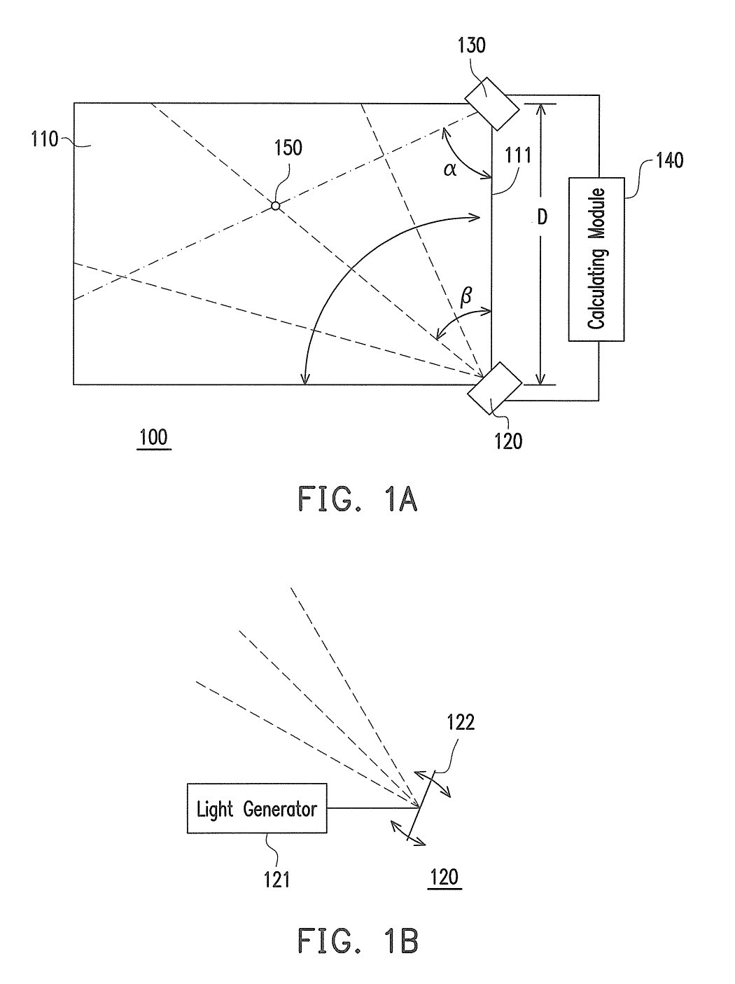

FIG. 1A is a schematic diagram illustrating an optical scanning type touch apparatus according to one exemplary embodiment. FIG. 1B is a schematic diagram illustrating the light scanning module of FIG. 1A. Referring to FIG. 1A and FIG. 1B, the optical scanning type touch apparatus 100 includes a touch area 110, a light scanning module 120, an imaging module 130, and a calculating module 140. The touch area 110 may be used in a TV screen, a computer screen, an image region projected by a projector, or the like, for touch operations.

The light scanning module 120 is disposed at one corner of the touch area 110 for emitting a scanning light scanning the touch area 110. As such, when an object 150 touches the touch area 110 and the scanning light travels to the object 150, a scattering light is produced.

The imaging module 130 is disposed at one corner of the touch area 110 that is adjacent the light scanning module 120, for receiving the scattering light produced by the scanning light travelling to the object 150 and calculating a first angle α between the scattering light and an edge 110 of the touch area 110 when the scattering light travels to the imaging module 130 (for example, the angle between the line interconnecting the object 150 and the imaging module 130 and the edge 111 of the touch area 110). The calculating module 140 is coupled to the light scanning module 120 and the imaging module 130, and calculates a position of the object 150 on the touch area 110 according to the first angle α, a second angle β, and a distance D between the light scanning module 120 and the imaging module 130. As used herein, the second angle β refers to the angle between the scanning light travelling to the object 150 and the edge 111 of the touch area 110 (for example, the angle between the line interconnecting the object 150 and the light scanning module 120 and the edge 111 of the touch area 110).

As shown in FIG. 1B, in this exemplary embodiment, the light scanning module 120 includes a light generator 121 and an oscillating mirror 122. The light generator 121 is used to generate a light and can be a laser diode, a light emitting diode, or another type of light generator. The oscillating mirror 122 is disposed at one side of the light generator 121 for reflecting the light onto the touch area 110 and can rotate back and forth to generate the scanning light to scan the touch area 110.

The following is an explanation of operation of the exemplary optical scanning type touch apparatus 100. In this exemplary embodiment, the light generator 121 of the light scanning module 120 first generates a light such as a laser light, and the oscillating mirror rotates back and forth in response to a driving voltage to generate the scanning light to scan the touch area 110. When the object 150 (for example, a user's finger or touch pen) touches the touch area 110 and the scanning light travels to the object 150, the scattering light is generated.

The scattering light then forms an image inside the imaging module 130 and, as such, the image module 130 obtains the first angle α between the line interconnecting the object 150 and the imaging module 130 and the edge of the touch area 110, and transmits the first angle α to the calculating module 140.

On the other hand, the light scanning module 120 of this exemplary embodiment outputs the angle of the scanning light scanning onto the object 150 to the calculating module 140, and the calculating module 140 can obtains the second angle β between the scanning light travelling to the object 150 and the edge 111 of the touch area 110 (i.e. the angle between the line interconnecting the object 150 and the light scanning module 120 and the edge 111 of the touch area 110). The calculating module 140 then plugs the first angle α, the second angle β and a distance D between the light scanning module 120 and the imaging module 130 into equation (1) and equation (2) below to calculate the correct position of the object 150 on the touch area 110.

$$\begin{matrix}X = \frac{sin α \times sin β}{sin ( α + β )} \times D & ( 1 ) \\ Y = \frac{cos α \times sin β}{sin ( α + β )} \times D & ( 2 )\end{matrix}$$

In equation (1) and equation (2), D is the distance between the light scanning module 120 and the imaging module 130, (X, Y) are the coordinates of the object 150 on the touch area 110, α is the first angle, and β is the second angle.

As such, in this exemplary embodiment, the light scanning module 120 cooperates with the imaging module 130 to obtain the position (X, Y) of the object 150 on the touch area 110, thus realizing the function of the touch operation. In addition, the user can adjust in real time the distance (indicated by D in FIG. 1) between the light scanning module 120 and the imaging module 130, i.e. the optical scanning type touch apparatus 100 of this exemplary embodiment can fit for touch area of any size and therefore has great utility and convenience.

While the above embodiment describes the operation in response to the touch of the object 150, it is to be understood that this exemplary embodiment is not intended to be limited to that. The operation in response to sequence or simultaneous touch of multiple objects is described below by way of examples.

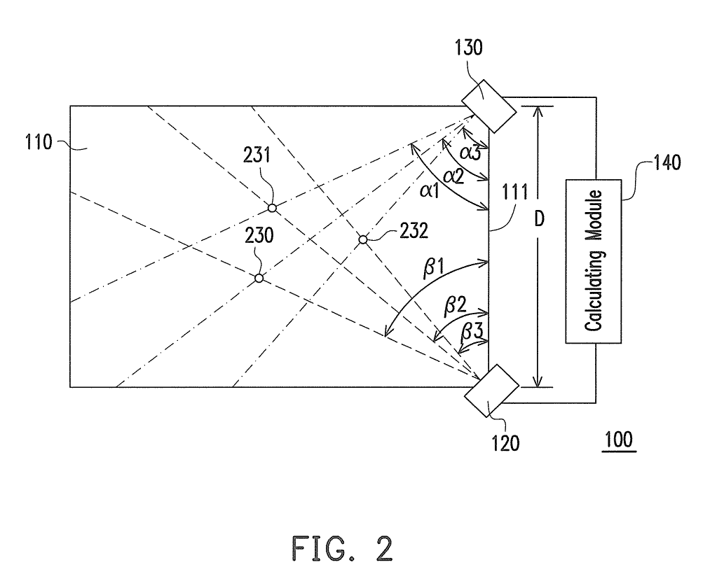

FIG. 2 is a schematic diagram illustrating multi-point touch of the optical scanning type touch apparatus 100 of FIG. 1A. Referring to FIG. 2, when objects 230, 231 and 232 simultaneously or sequentially touch the touch area 110, the scanning light sequentially travels to the objects 230, 231 and 232, thus sequentially producing scattering lights at different positions. At this time, the imaging module 130 sequentially receives the scattering lights produced by the scanning light travelling to the objects 230, 231 and 232, to obtain first angles α1 [symbol] α2 and α3, respectively, and transmit the first angles α1 [symbol] α2 and α3 to the calculating module 140.

On the other hand, the calculating module 140 obtains second angles β1 [symbol] β2 and β3 between the scanning light and the edge 111 of the touch area 110 when the scanning light sequentially travels to the objects 230, 231 and 232, respectively. As such, the calculating module 140 can calculate the positions of the objects 230, 231 and 232 on the touch area 110, i.e. the coordinates (X1, Y1), (X2, Y2) and (X3, Y3) of the objects 230, 231 and 232, according to the first angles α1, α2 and α3, the second angles β1 [symbol] β2 and β3, and the distance D between the light scanning module 120 and the imaging module 130. In this embodiment, the calculating module 140 sequentially obtains the positions at which the objects 230, 231 and 232 touch the touch area 110, thus avoiding misjudgement.

Another embodiment is described below to explain the operation of the optical scanning type touch apparatus when an object touches the touch area.

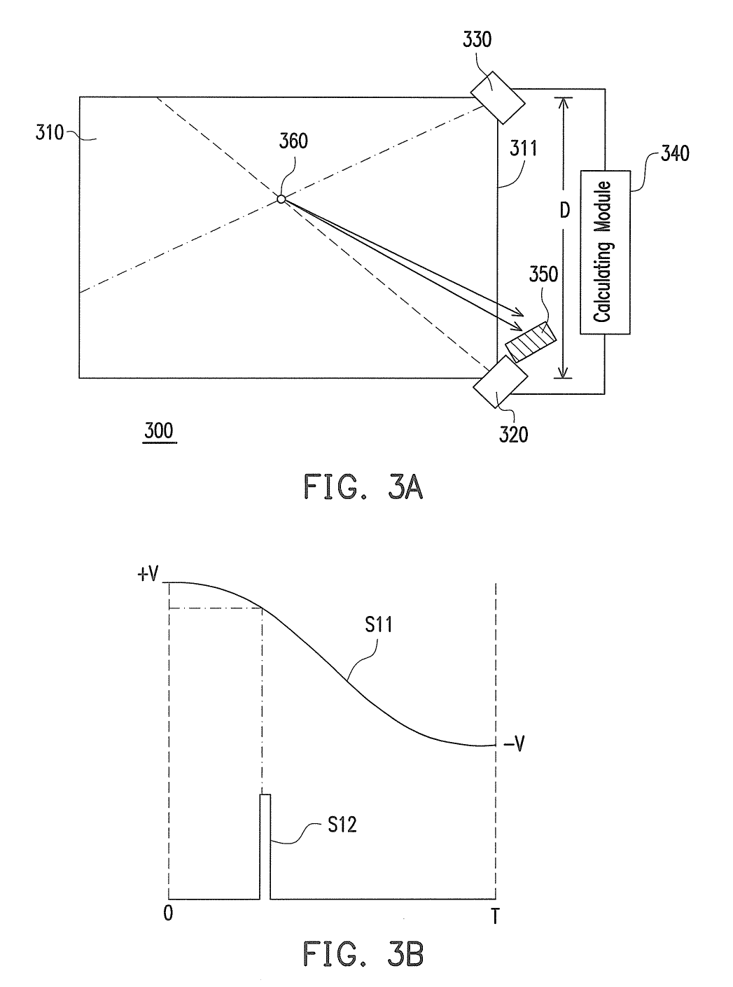

FIG. 3A is a schematic diagram illustrating an optical scanning type touch apparatus according to another exemplary embodiment. Referring to FIG. 3A, the optical scanning type touch apparatus 300 includes a touch area 310, a light scanning module 320, an imaging module 330, a calculating module 340, and an optical sensor 350. The touch area 310, light scanning module 320, imaging module 330, and calculating module 340 may be implemented and constructed in a similar manner as the touch area 110, light scanning module 120, imaging module 130 and calculating module 140 of FIG. 1A and, therefore, explanation thereof is not repeated herein.

Different from FIG. 1A, the optical scanning type touch apparatus 300 of this exemplary embodiment includes the optical sensor 350 such as a photo-diode or photo-sensor. The optical sensor 350 is disposed beside the optical scanning module 320 to receive the scattering light produced by the scanning light travelling to an object 360. Upon receiving the scattering light, the optical sensor 350 generates a sensing signal in real time and transmits the sensing signal to the calculating module 340. The calculating module 340 can obtain the second angle β according to the relationship between the pulse of the sensing signal and the corresponding driving voltage of the oscillating mirror of the light scanning module 320. As such, the calculating module 340 can calculate the position at which the object 360 touches the touch area 310 according to the first angle α obtained by the imaging module 330, the second angle β obtained as above, and the distance D between the light scanning module 320 and the imaging module 330. In this exemplary embodiment, the optical sensor 350 is not intended to be limited to being disposed beside the optical scanning module 320. Rather, the optical sensor 350 can be disposed at any location between the light scanning module 320 and the imaging module 330, or disposed beside the imaging module 330.

FIG. 3B is a schematic diagram illustrating the relationship between the pulse of the sensing signal and the corresponding driving voltage according to one exemplary embodiment. Referring to FIG. 3B, the curve S11 represents the driving voltage of the oscillating mirror, and the period of the driving voltage is denoted by T. The curve S12 represents the sensing signal of the optical sensor 350. Voltage +V and −V are driving voltages that the oscillating mirror (for example, the oscillating mirror 122 of FIG. 1B) requires at its maximum rotation angles. A driving voltage of zero represents that the rotation angle of the oscillating mirror is zero.

Therefore, in this embodiment, the sensing time of the optical sensor 350 is synchronous with the period of the driving voltage. That is, upon receiving the scattering light within the period T of the driving voltage, the optical sensor 350 generates in real time the sensing signal S12 (for example, the pulse of FIG. 3B) to the calculating module 340, such that the calculating module 340 calculates the angle between the scanning light and the edge 311 of the touch area 310 when the scanning light travels to the object 360, i.e. the second angle β, according to the relationship between the pulse of the sensing signal S12 and the corresponding driving voltage S11. The calculating module 340 then calculates the coordinates (X, Y) of the object 360 touching the touch area 310 by plugging the first angle α, the second angle β, and the distance D between the light scanning module 320 and the imaging module 330 into equation (1) and equation (2). In addition, this exemplary embodiment may also apply to the multi-point touch. Since the multi-point touch has been described with reference to the exemplary embodiment of FIG. 2, explanation thereof is not repeated herein.

Besides, the number of the optical sensor 350 is not intended to be limited to one in this exemplary embodiment. Rather, a plurality of optical sensors may be disposed between the light scanning module 320 and the imaging module 330, each for receiving the scattering light produced by the scanning light travelling to the object 360.

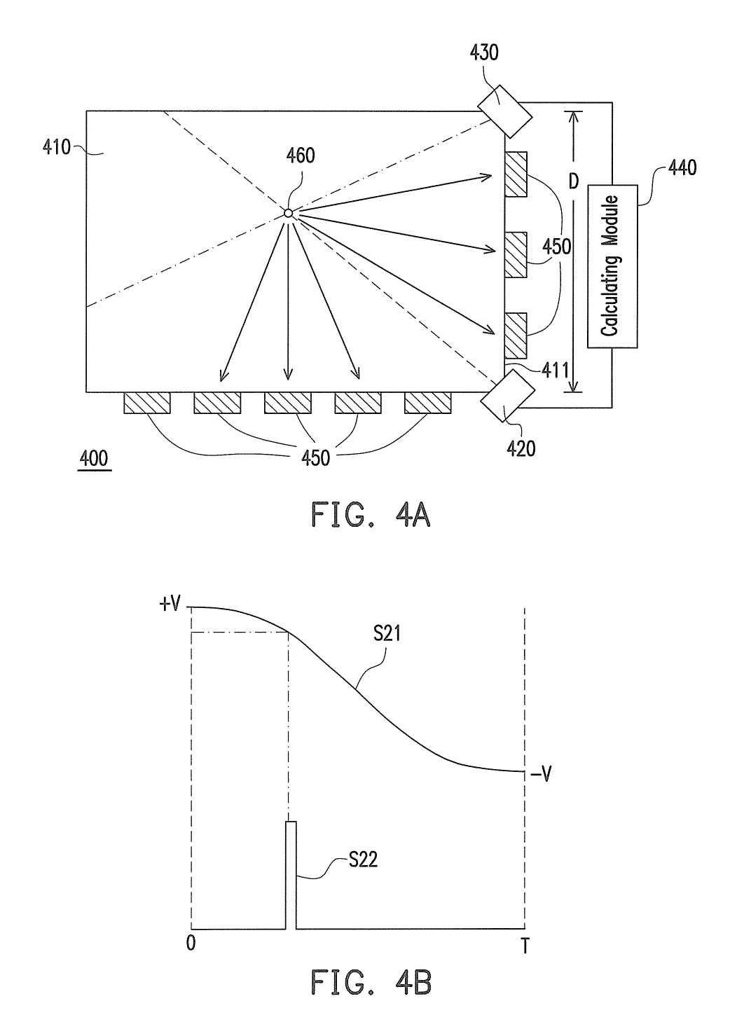

FIG. 4A is a schematic diagram illustrating an optical scanning type touch apparatus according to another exemplary embodiment. Referring to FIG. 4A, the optical scanning type touch apparatus 400 includes a touch area 410, a light scanning module 420, an imaging module, a calculating module 440, and a plurality of optical sensors 450. The touch area 410, light scanning module 420, imaging module 430 and calculating module 440 may be implemented and constructed in the similar manner as the touch area 110, light scanning module 120, imaging module 130 and calculating module 140 of FIG. 1A and, therefore, explanation thereof is not repeated herein. In addition, different from FIG. 1A, the optical sensing type touch apparatus 400 of this exemplary embodiment includes the plurality of optical sensors 450 for increasing the area of receiving the scattering light, thus increasing the accuracy of obtaining the second angle β by the calculating module 440.

In this exemplary embodiment, the plurality of optical sensors 450 are disposed at two sides of the light scanning module 420, for receiving the scattering light produced by the scanning light travelling to the object 460 to thereby generate a sensing signal and transmit the sensing signal to the calculating module 440. The calculating module 440 then obtains a second angle β according to the relationship between the pulse of the sensing signal and the corresponding driving voltage of the oscillating mirror (for example, the oscillating mirror 122 of FIG. 1B) of the light scanning module 420. As such, the calculating module 400 can obtain the position at which the object 460 touches the touch area 410 according to the first angle α obtained by the imaging module 430, the second angle β obtained as above, and the distance D between the light scanning module 420 and the imaging module 430.

FIG. 4B is a schematic diagram illustrating the relationship between the pulse of the sensing signal and the corresponding driving voltage according to one exemplary embodiment. In FIG. 4B, the curve S21 represents the driving voltage, and the period of the driving voltage is denoted by T. The curve S22 represents the sensing signal of the optical sensor. Voltages +V and −V are driving voltages that the oscillating mirror requires at its maximum rotation angles. A driving voltage of zero represents that the rotation angle of the oscillating mirror is zero.

Therefore, in this exemplary embodiment, the sensing time of the optical sensor 450 is synchronous with the period of the driving voltage. That is, upon receiving the scattering light within the period T of the driving voltage, the optical sensor 450 generates in real time the sensing signal to the calculating module 440. The calculating module 440 then calculates the angle between the scanning light and the edge 411 of the touch area 410 when the scanning light travels to the object 460, i.e. the second angle β, according to the relationship between the pulse of the sensing signal S22 and the corresponding driving voltage S21, i.e. by looking up in a look-up table. The calculating module 440 then calculates the coordinates (X, Y) of the object 460 touching the touch area 410 by plugging the first angle α, the second angle β, and the distance D between the light scanning module 420 and the imaging module 430 into equation (1) and equation (2). In addition, this exemplary embodiment may also apply to the multi-point touch. Since the multi-point touch has been described with reference to the exemplary embodiment of FIG. 2, explanation thereof is not repeated herein.

Another embodiment is described below to explain the operation of the optical scanning type touch apparatus when an object touches the touch area.

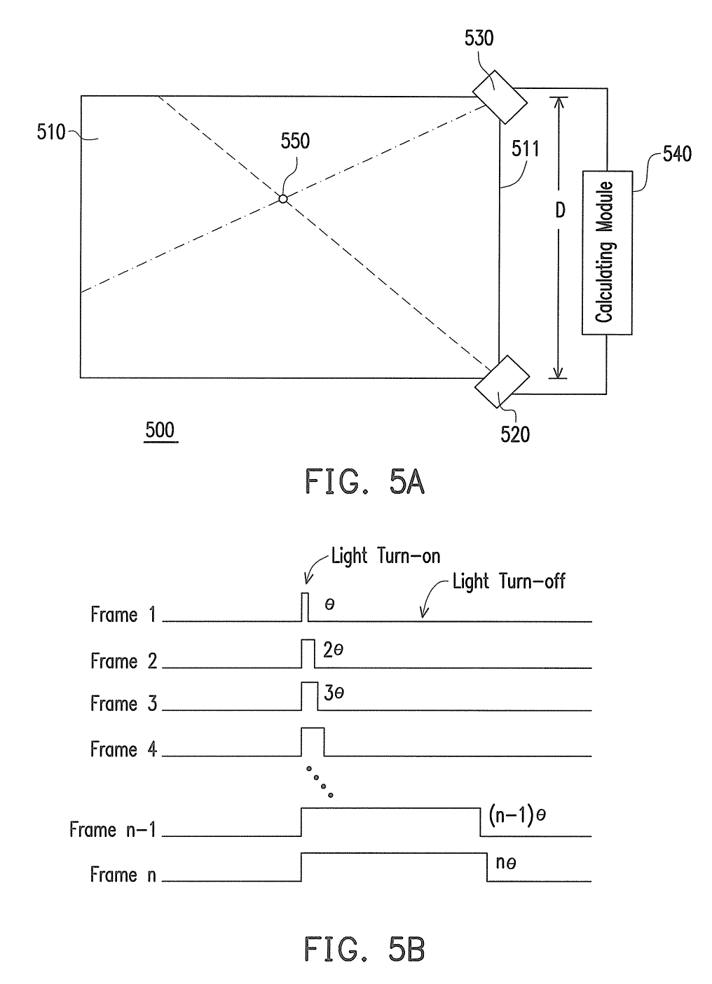

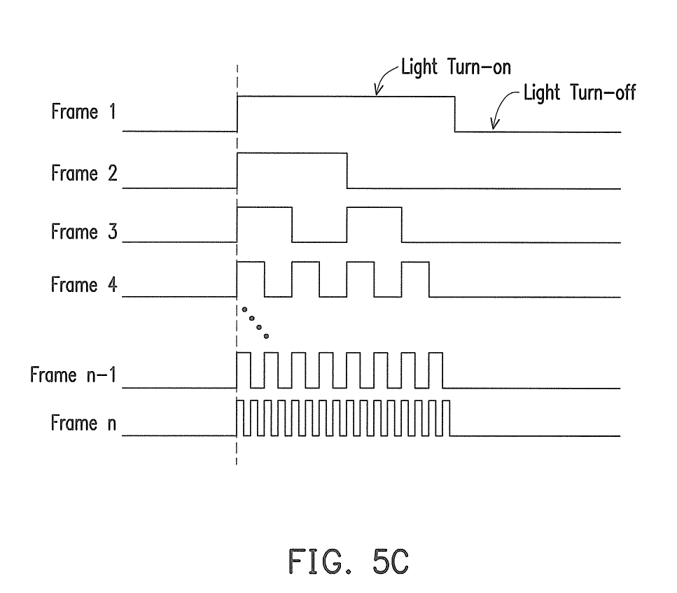

FIG. 5A is a schematic diagram illustrating an optical scanning type touch apparatus according to another exemplary embodiment. Referring to FIG. 5A, the optical scanning type touch apparatus 500 includes a touch area 510, a light scanning module 520, an imaging module 530, and a calculating module 540. The light scanning module 520 is disposed at one corner of the touch area 510, for generating a light scanning the touch area 510. The light scanning module 520 sequentially adjusts turn-on and turn-off period of the scanning light according to the image recording sequence of the imaging module 530. That is, when the oscillating mirror (for example, the oscillating mirror 122 shown in FIG. 1B) of the light scanning module 520 is rotated within a specific range of angles, the light scanning module 520 turns on the scanning light. However, when the oscillating mirror of the light scanning module 520 is rotated within the remaining range of angles, the light scanning module 520 turns off the scanning light. For example, when the oscillating mirror is rotated from 0 to 3 degrees, the light scanning module 520 turns on the scanning light. However, when the oscillating mirror is rotated from 3 to 90 degrees, the light scanning module 520 turns off the scanning light. As a result, the scanning light generated by the light scanning module 520 scans the touch area within the scanning angle range of 0 to 3 degrees.

Therefore, when an object 550 touches the touch area 510 and the imaging module 530 captures the scattering light reflected by the object 550, the calculating module 550 can obtain the second angle β according to the image recording sequence of the imaging module 530.

This exemplary embodiment is further described below with reference to FIG. 5B which illustrates the image recording sequence of the imaging module 530 and the light switching sequence, in which the light scanning angle is adjusted by increasing a predetermined angle each time. It is further assumed that the maximum scanning angle of the scanning light scanning the touch area is ninety degrees (i.e. the angle between two sides of the touch area 510 adjacent the light scanning module 520). Referring to FIG. 5A and FIG. 5B, when the imaging module 530 records a first image frame (Frame 1), the scanning light generated by the light scanning module 520 scans the touch area 510 within the scanning angle range of 0 to 3 degrees. That is, the light scanning module 520 turns on the scanning light when the scanning angle is within 0 to 3 degrees, but turns off the scanning light when the scanning angle is within 3 to 9 degrees. Likewise, when the imaging module 530 records a second image frame (Frame 2), the scanning light generated by the light scanning module 520 scans the touch area 510 within the scanning angle range of 0 to 6 degrees. That is, the light scanning module 520 turns on the scanning light when the scanning angle is within 0 to 6 degrees, but turns off the scanning light when the scanning angle is within 6 to 90 degrees. Operations when recording other image frames (i.e. Frame 3 to Frame n) can be deduced by analogy, where Frame n represents the image frame the light scanning module 520 records when finishing scanning the whole touch area 510.

The imaging module 530 is disposed at another corner of the touch area 510 adjacent the light scanning module 520, for receiving the scattering light produced by the scanning light travelling to the object 550 so as to obtain a first angle α between the scattering light and an edge 511 of the touch area 510 when the scattering light travels to the imaging module 530. The calculating module 540 is coupled to the light scanning module 520 and the imaging module 530 to obtain the second angle β by determining in which frame the imaging module 530 captures the scattering light. As such, the calculating module 540 can calculate the position of the object 550 on the touch area 510 according to the first angle α, the second angle β and the distance between the light scanning module 520 and the imaging module 530.

In this exemplary embodiment, the value of the predetermined angle may vary with the imaging rate of the imaging module 530. For example, it is assumed that the imaging rate of the imaging module 530 is 30 frames/sec, and the maximum light scanning angle is 90 degrees. As such, the predetermined angle is 90/30=3 degrees/frame, that is, the scanning angle range within which the scanning light is turned on is increased by three degrees for each time of scanning the touch area 510.

In the above description, the scanning angle range within which the scanning light is turned on is adjusted in an accumulation manner in the image recording sequence of the imaging module 530. That is, for Frame 1, the light scanning module 520 turns on the scanning light within the scanning angle range of 0 to 3 degrees; for Frame 2 later, the light scanning module 520 turns on the scanning light within the scanning angle range of 0 to 6 degrees. However, the scanning angle range within which the scanning light is turned on may be fixed in the image recording sequence of the imaging module 530. For example, for Frame 1, the light scanning module 520 turns on the scanning light within the scanning angle range of 0 to 3 degrees; for Frame 2 later, the light scanning module 520 turns on the scanning light within the scanning angle range of 3 to 6 degrees, and the rest of the touch area is scanned in the same manner so as to complete the scan to the whole touch area.

In addition, in this exemplary embodiment, the imaging rate of the imaging module 530 is not intended to be limited to 30 frames/sec as above. Rather, the imaging rate can be modified according to needs. For example, when the imaging rate of the imaging module 530 is 60 frame/s, the scanning angle can be divided into 90/60=1.5 degrees/frame, i.e. the predetermined angle is 1.5 degrees. That is, there is an increment scanning angle of 1.5 degrees for each frame, or the scanning angle range is fixed to be 1.5 degrees for each frame. When the imaging rate of the imaging module 530 is 90 frames/sec, the scanning angle is divided into 90/90=1 degree/frame, i.e. the predetermined angle is 1 degree. As such, a higher imaging rate of the imaging module 530 can cause the light scanning angle to be divided more finely, thus making the obtained position of the object 550 touching the touch area 510 more accurate.

Moreover, in the above exemplary embodiment, the predetermined angle (for example, indicated by θ of FIG. 5B) is increased to accumulate the scanning angle range within which the scanning light is turned on, or adjust the scanning angles but maintain the scanning angle range. However, these are illustrative rather than limiting. Another embodiment is described below to discuss adjustment of the scanning angles in another manner.

In another exemplary embodiment, the light scanning angle range is reduced in a bisection manner. This exemplary embodiment is described below with reference to FIG. 5C which illustrates the image recording sequence of the imaging module 530 and the light switching sequence. Referring to FIG. 5A and FIG. 5C, when the imaging module 530 records the first image frame (Frame 1), the light scanning module 520 turns on the scanning light over the scanning angle range of 0 to 90 degrees. When the imaging module 530 records the second image frame (Frame 2), the light scanning module 520 turns on the scanning light over the scanning angle range of 0 to 45 degrees, but turns off the scanning light over the scanning angle range of 45 to 90 degrees. When the imaging module 530 records the third image frame (Frame 3), the light scanning module 520 turns on the scanning light over the scanning angle range of 0 to 22.5 degrees and the range of 45 to 67.5 degrees, but turns off the scanning light over the scanning angle range of 22.5 to 45 degrees and the range of 67.5 to 90 degrees.

Similarly, when the imaging module 530 records an eighth image frame (Frame 8), the light generated by the light scanning module 520 is switched on or off at about every 0.7 degrees, i.e. the scanning light is sequentially turned on over the scanning angle range of 0 to 0.7 degrees, the range of 1.4 to 2.1 degrees, . . . , and the range of 88.6 to 89.3 degrees, but turned off over the scanning angle range of 0.7 to 1.4 degrees, the range of 2.1 to 2.8 degrees, . . . , and the range of 89.3 to 90 degrees. As such, the light scanning module 520 progressively reduces the scanning angle range in the image recording sequence of the imaging module 530, and the calculating module 540 can thus obtain the angle between the scanning light and the edge of the touch area 510 when the object 550 touches the touch area 510, i.e. the second angle β.

For example, when the object 550 touches the touch area 510, the scanning light generated by the light scanning module 520 scans over the scanning range of 0 to 90 degrees. The scanning light travels to the object 550 to produce a scattering light. When the imaging module 620 receives the scattering light, it indicates that there is an object touching the touch area 510. The scanning angle range is reduced in above-described bisection manner to reduce the angle range of the object 550 touching the touch area 510, until the imaging module 530 records an image frame such as the eighth frame (Frame 8 of FIG. 5B), at which time the scanning angle range has been reduced to 0.7 degrees. The second angle β between the scanning light and the edge 511 of the touch area 510 when the scanning light travels to the object 650 can thus be obtained. The calculating module 540 then calculates the correct position of the object 550 touching the touch area 510 according to the obtained first angle α, the second angle β and the distance D between the light scanning module 520 and the imaging module 530.

In addition, if the imaging rate of the imaging module is 120 frames/sec, and the resolution of the scanning angle adjustment is required to be less than 1 degree, the calculating module 540 can perform 120/8=15 times of calculations. Therefore, the optical scanning type touch apparatus 500 of this exemplary embodiment can effectively reduce the calculating time and improve the accuracy of calculating the coordinates of the object 550 on the touch area 510.

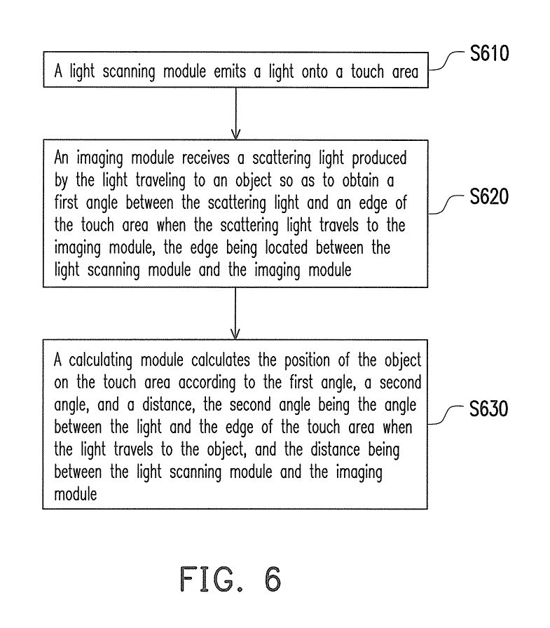

An operation method of an optical scanning type touch apparatus can be generalized from the above exemplary embodiments. FIG. 6 illustrates a flow chart of an operation method of an optical scanning type touch apparatus according to one exemplary embodiment. The optical scanning type touch apparatus includes a light scanning module and an imaging module. Referring to FIG. 6, at step S610, the light scanning module emits a scanning light scanning a touch area. At step S620, the imaging module receives a scattering light produced by the scanning light travelling to an object, to obtain a first angle between the scattering light and an edge of the touch area when the scattering light travels to the imaging module. The edge is located between the light scanning module and the imaging module. At step S630, the position of the object touching the touch area is calculated according to the first angle, a second angle, and a distance. The second angle refers to the angle between the scanning light and the edge of the touch area when the scanning light travels to the object, and the distance refers to the distance between the light scanning module and the imaging module.

In addition, in the above exemplary embodiment, in obtaining the second angle, at least one optical sensor can be used to receive the scattering light to generate a sensing signal. The calculating module then obtains the second angle according to the sensing signal. Specifically, the calculating module obtains the second angle according to the relationship between the pulse of the sensing signal and the corresponding driving voltage of the oscillating mirror of the light scanning module.

Moreover, in the above exemplary embodiment, another manner of obtaining the second angle is that the light scanning module sequentially adjusts the turn-on and turn-off periods of the scanning light according to the image recording sequence of the imaging module. When the imaging module captures the scattering light produced by the scanning light travelling to the object, the calculating module then obtains the second angle according to the image recording sequence. The light turn-on period is adjusted such that the scanning angle range is accumulated with a predetermined angle each time, and the value of the predetermined angle varies according to the imaging rate of the imaging module. In another embodiment, the light turn-on period is adjusted such that the scanning angles are increased progressively while the scanning angle range is maintained at a fixed predetermined angle. In still another embodiment, the light turn-on period is adjusted such that the scanning angle range is reduced each time in a bisection manner.

In summary, in this disclosure, a light scanning module generates a scanning light scanning a touch area. When an object touches the touch area and the scanning light travels to the object, the scanning light produces a scattering light. An imaging module receives the scattering light to obtain a first angle between the scattering light and an edge of the touch area when the scattering light travels to the imaging module and transmits the first angle to a calculating module. In addition, the light scanning module transmits a scanning angle of the scanning light, i.e. a second angle between the scanning light and the edge of the touch area when the scanning light travels to the object, to the calculating module. The calculating module then calculates the position of the object touching the touch area according to the first angle, the second angle and a distance between the light scanning module and the imaging module. As such, this disclosure can successfully obtain the position of the object touching the touch area.

In addition, this disclosure utilizes only one light scanning module and one imaging module. Therefore, the cost of circuit components can be reduced. Besides, the distance between the light scanning module and the imaging module can be adjusted in real time such that the optical scanning type touch apparatus can fit for touch area of any size. Moreover, in this disclosure, the accuracy of obtaining the second angle can be further improved by adding at least one optical sensors or adjusting the light turn-on period according to the image recording sequence of the imaging module.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical scanning type touch apparatus comprising:
a touch area;
a light scanning module disposed at one corner of the touch area and adapted to generate a scanning light scanning the touch area;
an imaging module disposed at another corner of the touch area adjacent the light scanning module and adapted to receive a scattering light produced by the scanning light travelling to an object so as to obtain a first angle; and
a calculating module coupled to the light scanning module and the imaging module and adapted to calculate the position of the object on the touch area according to the first angle, a second angle, and a distance between the light scanning module and the imaging module.

2. The optical scanning type touch apparatus according to claim 1, wherein the light scanning module comprises:
a light generator adapted to generate a light; and
an oscillating mirror disposed at one side of the light generator and adapted to reflect the light so as to generate the scanning light to scan the touch area.

3. The optical scanning type touch apparatus according to claim 2, wherein the light generator is a laser diode or a light emitting diode.

4. The optical scanning type touch apparatus according to claim 2, further comprising:
an optical sensor adapted to receive the scattering light so as to generate a sensing signal and transmit the sensing signal to the calculating module, wherein the calculating module is adapted to obtain the second angle according to the sensing signal.

5. The optical scanning type touch apparatus according to claim 4, wherein the optical sensor is disposed beside the light scanning module.

6. The optical scanning type touch apparatus according to claim 4, wherein the calculating module is adapted to obtain the second angle according to a temporal relationship between a pulse of the sensing signal and the corresponding driving voltage of the oscillating mirror of the light scanning module.

7. The optical scanning type touch apparatus according to claim 2, further comprising:
a plurality of optical sensors disposed at at least one side of the touch area adjacent the light scanning module and adapted to receive the scattering light so as to generate a sensing signal and transmit the sensing signal to the calculating module, wherein the calculating module is adapted to obtain the second angle according to the sensing signal.

8. The optical scanning type touch apparatus according to claim 7, wherein the calculating module is adapted to obtain the second angle according to a temporal relationship between a pulse of the sensing signal and the corresponding driving voltage of the oscillating mirror of the light scanning module.

9. The optical scanning type touch apparatus according to claim 1, wherein the light scanning module is adapted to sequentially adjust a turn-on period of the scanning light according to an image recording sequence of the imaging module, such that the calculating module obtains the second angle according to the imaging recording sequence when the imaging module captures the scattering light generated by the scanning light travelling to the object.

10. The optical scanning type touch apparatus according to claim 9, wherein the light turn-on period is adjusted such that the scanning angle is accumulated with a predetermined angle each time.

11. The optical scanning type touch apparatus according to claim 10, wherein the value of the predetermined angle varies according to the imaging rate of the imaging module.

12. The optical scanning type touch apparatus according to claim 9 wherein the light turn-on period is adjusted such that the scanning angles are increased progressively while the scanning angle range is maintained at a fixed predetermined angle.

13. The optical scanning type touch apparatus according to claim 9, wherein the light turn-on period is adjusted such that the scanning angle range is reduced each time in a bisection manner.

14. The optical scanning type touch apparatus according to claim 1, wherein the first angle refers to the angle between the scattering light and the edge of the touch area when the scattering light travels to the imaging module, the second angle refers to the angle between the scanning light and the edge of the touch area when the scanning light travels to the object, and the edge is located between the light scanning module and the imaging module.

15. An operation method of an optical scanning type touch apparatus, the optical scanning type touch apparatus comprising a light scanning module, an imaging module, and a calculating module, the operation method comprising:
using a light scanning module to emit a scanning light onto a touch area;
using the imaging module to receive a scattering light produced by the scanning light travelling to an object so as to obtain a first angle between the scattering light and an edge of the touch area when the scattering light travels to the imaging module, the edge being located between the light scanning module and the imaging module; and
using a calculating module to calculating the position of the object on the touch area according to the first angle, a second angle, and a distance, the second angle being the angle between the scanning light and the edge of the touch area when the scanning light travels to the object, and the distance being between the light scanning module and the imaging module.

16. The operation method of the optical scanning type touch apparatus according to claim 15, further comprising:
using at least one optical sensors to receive the scattering light so as to generate a sensing signal; and
using the calculating module to obtain the second angle according to the sensing signal.

17. The operation method of the optical scanning type touch apparatus according to claim 16, wherein the step of obtaining the second angle according to the sensing signal comprises obtaining the second angle according to a relationship between a pulse of the sensing signal and the corresponding driving voltage of an oscillating mirror of the light scanning module.

18. The operation method of the optical scanning type touch apparatus according to claim 15, further comprising:
using the light scanning module to sequentially adjust the turn-on period of the scanning light according to an imaging recording sequence of the imaging module; and
using the calculating module to obtain the second angle according to the imaging recording sequence when the imaging module captures the scattering light produced by the scanning light travelling to the object.

19. The operation method of the optical scanning type touch apparatus according to claim 18, wherein the light turn-on period is adjusted such that the scanning angle is accumulated with a predetermined angle each time.

20. The operation method of the optical scanning type touch apparatus according to claim 19, wherein the value of the predetermined angle varies according to the imaging rate of the imaging module.

21. The operation method of the optical scanning type touch apparatus according to claim 18, wherein the light turn-on period is adjusted such that the scanning angles are increased progressively while the scanning angle range is maintained at a fixed predetermined angle.

22. The operation method of the optical scanning type touch apparatus according to claim 18, wherein the light turn-on period is adjusted such that the scanning angle range is reduced each time in a bisection manner.
